(19) United States
(12) Patent Application Publication
(10) Pub. No.: US 2016/0335902 A1
(43) Pub. Date: Nov. 17, 2016

(54) COMPUTERIZED SYSTEM FOR PROVIDING ACTIVITIES

(71) Applicant: Dan Dan YANG, Ottawa (CA)

(72) Inventor: Dan Dan YANG, Ottawa (CA)

(21) Appl. No.: 15/224,106

(22) Filed: Jul. 29, 2016

Related U.S. Application Data
(63) Continuation-in-part of application No. 13/684,424, filed on Nov. 23, 2012.

(51) Int. Cl. G09B 5/12; G09B 19/02; G09B 19/00; G09B 5/04

(52) U.S. Cl. CPC G09B 5/125; G09B 5/04; G09B 19/025; G09B 19/00

(57) ABSTRACT

Systems, methods, and devices for providing a learning diagnosis structure which quantifies each learner's profile and provides relevant activities based on each learner's profile. As well, an analysis of the learner's progress relative to a comparable group of learners is provided. Should the learner be lagging behind the performance of the comparable group, suitable activities are selected and presented to the learner to bolster the learner's performance. Included are assessments of the areas in which the learner is lagging, and the provision of learning material which have been mapped to a learner's specific profile and educational progress.

### RELATED APPLICATIONS

This application is a Continuation in Part of U.S. application Ser. No. 13/684,424 filed Nov. 23, 2012.

### TECHNICAL FIELD

The present invention relates to educational systems. More specifically, the present invention relates to systems, methods, and devices which provide automatic lessons and activities for learners based on their progress with their education. In addition to providing systems, methods, and devices which can be used for individualized assessments of each learner's progress level, the present invention can also be used in a multi-faceted approach to diagnosing and determining root causes of a specific child's problems including physical issues, learning issues, and developmental issues.

### BACKGROUND

The increasing encroachment of digitization and computers into the daily life of the 21st century is well-known. Computers and digital data are increasingly replacing the analog world of pen, paper, and printed materials. This steady encroachment has not spared the educational world as computers, digital devices, tablets, and other computing devices are increasingly being used for educational purposes in classrooms and homes everywhere. The rise of the tablet computing devices as well as the smartphone ushers in a new era of learner computing. In the classroom or at home, these devices provide quite a few advantages—they deliver a large amount of learning materials to the fingertips of learners, thereby making the learning fun and interactive and their size and weight make them very accessible to younger learners.

However, none of the presently available desktop computers, tablets, or learner computing devices do more than deliver learning materials. In other words, none of the existing computing devices provide opportunities where learners not only access learning materials in order to gain new knowledge, but which also collect and analyze learner's associated data to arrive at a learner's learning profile. Such a profile can be used to gain insight into the learner's actual learning process so that more personalized learning materials can be automatically presented to the learner. As well, none of the current systems assess each learner based on the performance of other learners. Such an analysis can reveal whether a specific learner is learning or progressing at the same pace as the other learners or whether that specific learner is lagging behind the others.

From the above, it should be clear that no current systems or applications, for school or home, allow educators to quantify each learner's progress and capabilities. As an example, it is fairly common to hear people, whether it is the teacher, the parent, or the student himself note that 6-year Johnny is “not good at counting”. However, neither Johnny nor teacher nor the parents can tell the exact area in which Johnny is failing. Did Johnny get the wrong result because Johnny has issues with sequential order or did Johnny get the wrong result because he counts some numbers more than once?

Similarly, no current systems or applications base their recommendations on the learner's user profile. Current systems also only work with educators and are not stand alone systems which analyze, present, and assess each learner based on that learner's continuing progress.

It should be noted that no existing systems target very young children who may have fallen behind or who are falling behind their peers or behind other children of a similar age or background. Issues with learning in specific subjects or with physical, speech, or coordination based skills may be hard to detect at a young age and may lead to other, more problematic issues. Should such issues continue, they may lead to problems with self-esteem, problems in school, or behavioural issues. As such, it would be greatly advantageous if such issues can be caught and addressed at an early age.

Based on the above, there is therefore a need for systems and methods which allow for the use of computing devices, including desktops and/or portable computing devices, in classrooms and homes to assist in learning by delivering learning materials while, at the same time, gathering a learner's learning data so that this data can be analyzed. Once analyzed, they can be used to provide individualised and targeted learning materials specific to each issue during the learning process. Preferably, such a system would analyze and address each learner's learning status, weaknesses, strengths, and learning progress with appropriate learning materials being mapped to each learner's capabilities.

### SUMMARY

The present invention provides systems, methods, and devices for providing a learning diagnosis structure which quantifies each learner's profile and provides relevant activities based on each learner's profile. As well, an analysis of the learner's progress relative to a comparable group of learners is provided. Should the learner be lagging behind the performance of the comparable group, suitable activities are selected and presented to the learner to bolster the learner's performance. Included are assessments of the areas in which the learner is lagging, and the provision of learning material which have been mapped to a learner's specific profile and educational progress.

The present invention can be part of a multi-faceted, personal approach to diagnosing child issues with physical, mental, and potentially psychological problems. A child's performance issues in school may be traced to earlier issues with skills and abilities that were either undeveloped or insufficiently developed. As these skills or abilities languished, other skills and abilities, which may depend on the earlier skills, similarly remain undeveloped or underdeveloped. As an example, a child might not have developed suitable reading skills for his or her age may have an issue with recognizing the shapes of letters and this issue may be traceable to his or her infancy. The database of a child's performances when interacting with the present invention can provide a wealth of knowledge for someone diagnosing or trying to determine the roots of a child's issues. The results of each interaction that a child has with the present invention allow for the gathering of data that provides a more complete picture of the child's developmental process. These results in various areas can be mapped and extrapolated to determine future potential issues and to determine remedial actions to avoid or mitigate these future potential issues.

The present invention can thus be part of a system that measures and assesses a child's developmental status in a multi-faceted way. A child's developmental status can be measured using content that is fun to a child, including games and similar activities. As part of the system, questions directed to the child's caregivers can be used to gather and assess data relating to various areas including the child's motor skills, language skills, cognitive/logic reasoning skills, social-emotional skills. This data provides a holistic view of each child's development in multiple interlocking and interrelating areas. Unlike traditional/existing systems, the data gathered not only indicates if a child can or cannot perform a task, but, by using data gathered from different interrelated area, can also provide potential reasons for the child's performance or lack thereof.

In the present invention, computing devices are networked and configured for learning material delivery, data gathering, analysis and reporting as well as delivering in real time learning materials based on the analysis of the data gathered.

These computing devices include learner computing devices, educators computing devices, and data hosting/analysis computer servers. For home use, typically these computer devices can be combined into one desktop or laptop computer. For school use, these computers may include a student's computer or tablet computer, a teacher's computer or tablet computer, and a remote server. Other options are, of course, possible. These computing devices may be in the form of automated teaching assistants, devices programed with automated avatars, and/or surrogate automated teachers.

The learner computing devices serve to receive learning materials, to gather each learner's performance data into an individual learner performance database every time the learner uses learning material, and to upload the learner's performance data to a cumulative learner performance database housed on a data server. In one implementation, the learning material has predetermined cumulative target milestones and the learner's progress in achieving these milestones while using the learning material can be data mined. Each learner's progress can thus be mapped to the milestone achievement database. Similarly, each learner's progress can be compared to a comparable learner group's progress or performance.

Learner data for each individual learner can be provided in a report format for storage in the individual learner performance database as well as in the cumulative learner performance database. This learner data can be used as the basis for automatically selecting and providing learning materials that are standard or individualized based on the learner's progress. Based on the progress of the learner relative to the progress of the comparable learner group, specific educational activities are provided to the learner to either advance the learner or for the learner to catch up to the group's performance level.

A computer server performs the function of collecting performance data gathered from each learner computing device. The server aggregates this collected data into a cumulative learner performance database stored on the server. Data analysis on each learner's performance data, including mapping the learner performance data to the targeted milestones may be performed by the server or by the learner computing device.

It should be noted that, in addition to the individual learner performance database and the cumulative learner performance database, an activity database, housed partially by the server and partially by the learner computing device, is also used. The activity database includes modules for execution by the learner computing device. When executed, these modules provide learners with activities for teaching or reinforcing skills relating to one or more subjects.

In a first aspect, the present invention provides a system for delivering activity content to a learner, the system comprising a server, multiple databases, and a learner computing device. One of the databases, a cumulative learner performance database on said server, is for storing results of attempts at completion of activities by said learner and other learners. This cumulative learner performance database is updated after every attempt at completion of an activity by said learner.

For this system, the learner computing device is for use said learner and is in communication with said server. This at least one learner computing device determines an activity to be presented to said learner.

Another database used in the system is an individual learner performance database resident on said learner computing device. This individual learner performance database is for tracking a progress of said learner and is updated with said learner's performance whenever said learner interacts with an activity on said learner computing device. The individual learner performance database stores at least one performance metric for said learner for at least one activity accessed through said at least one learner computing device.

A third database used by the system is an activity database storing a plurality of digital activities for presentation to said learner by way of said learner computing device. The learner computing device automatically selects at least one activity from said activity database.

The system operates with the learner computing device communicating with said server to retrieve performance data relating to at least one skill or subject from said cumulative learner performance database for other learners who are comparable to said learner in at least one general profile characteristic. The learner computing device retrieves said learner's performance relating to said at least one skill or subject from said individual learner performance database. Once the data has been retrieved, the learner computing device performs a comparison of said performance data from said cumulative learner performance database with performance data for said learner from said individual learner performance database to determine which activity to present to said learner.

Note that, after every interaction by said learner with an activity on said learner computing device, said learner computing device uploads to said server results of said interaction to thereby update said cumulative learner performance database. The system operates well when the learner is a child of under 60 months in age.

In addition to the above databases, the system can include a reference database containing a complete list of achievement milestones and sub-milestones with age and level references. These milestones, of course, relate to the various activities contained in the activity database. The collected data from the learner are compared with these milestones. The system also includes a learner specific database containing data collected from the learner, the data collection occurring whenever the learner uses specific learning material that contains pre-determined achievement milestone targets. This learner specific database has a specific learner profile which contains learner achievement records based on the target milestones. For this system, the learner computing device delivers the learning activity to the learner, the learner computing device gathers data regarding the performance of the learner in the activity and sends the data as a database entry to at least one of the databases.

At least one database entry stored by the learner performance databases and originating from the learner computing device details: an activity through a specific learning material, an identity of the learner which may include learner's name, age, and a result or results of the activity for the learner.

In one implementation, each activity relates to at least one milestone and data collected for one of the learner databases includes data on said learner and which milestones have been achieved by said learner. As well, each database entry collected by said learner database and originating from said learner computing device details an activity and at least one result of said activity for said learner. The database entry stored in a database may include the results of an analysis of the learner's performance in the activity when compared to the reference database which contains the target achievement milestones. The database entry may also include the learner's achievements relative to the entries in the reference database. Thus, if a learner fails at an activity or performs better than expected at an activity, the learner's performance is compared with other milestones that may be surpassed or achieved by the user's performance. A learner can therefore “jump” ahead by achieving milestones that may otherwise not be attainable by a better than expected result. Similarly, if a learner fails at an activity, the learner may not achieve the milestone at which the activity is aimed at but a lower level milestone or a different milestone may be achieved.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention; and

FIGS. 2 and 2A are examples of plots of the progress of different learner compared to a group's progress; and

FIG. 3 is a flowchart detailing the steps in a method according to another aspect of the invention.

### DETAILED DESCRIPTION OF THE INVENTION

Within this document, it should be understood that the term “learner” encompasses a young person who is in the process of learning, whether in a formalized learning environment or not. This includes children who might be learning on their own or who may be coached or assisted by an older instructor. The term “educator”, in this document, includes any person or group of persons who are educating, instructing or who are assisting in the education, instruction, of a learner. Thus, a learner may be a child at home learning on their own (or guided by an older relative or a tutor) or a student in a classroom being taught by a teacher in a traditionally structured environment. Similarly, an educator may be a parent assisting their child, a teacher in a classroom setting, a tutor with one or more pupils, or any other person who may be involved in teaching, instructing, or otherwise educating a person. Preferably, the learner is a child who is 5 years of age or younger.

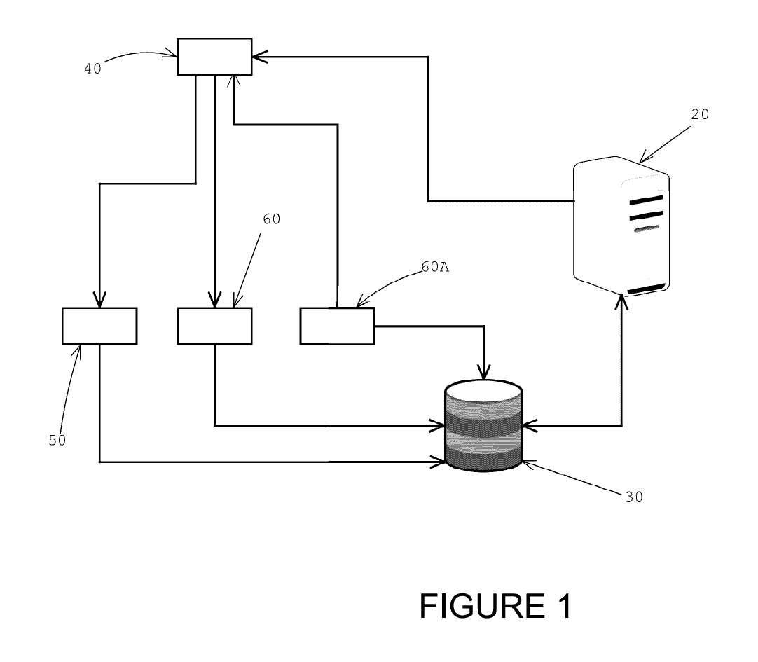

Referring to FIG. 1, a block diagram of a system according to one aspect of the invention is illustrated. In the system 10, a server 20 operates to store, update, and maintain a cumulative learner performance database 30. A learner computing device 40 is in communication (preferably wirelessly) with the server 20. Resident in the device 40 is an individual learner performance database 50. The individual learner performance database 50 is updated whenever the learner uses the device 40 for a learning activity provided by the system 10. Also part of the device 40 is an activity database 60 that contains modules for various activities available to the learner by way of the device 40. It should be noted that, in some implementations of the present invention, another part of the activity database 60A is resident on the server 20. The device 40 can, if necessary, download more activities and modules for presenting these activities from the server 20.

The system 10 operates with the learner using the device 40 to participate/complete an activity presented by the device 40. As will be explained below, the activity can be a game, puzzle, or any other activity accessible by way of the device 40. Every time the learner uses the device 40 to complete/participate in an activity provided by the system, the individual learner performance database 50 on the device 40 is updated with the learner's performance. The activity, the parameters of the activity, the details regarding the activity, the result of the activity (e.g. whether the activity was successfully completed/not completed, how long it took to complete the activity, how many correct/incorrect entries for the activity were made, etc.) and the learner's performance in accomplishing (or not accomplishing) the activity are all documented and stored in the individual learner performance database 50. Once stored in the individual learner performance database 50, the learner performance data for that instance of the learner's use of the device 40 is then uploaded to the cumulative learner performance database 30. The cumulative learner performance database 30 stores the learner performance data for all learners using various devices 40 which use the system 10. This database 30 allows for the cumulative and continuous gathering of performance data for various learners at different ages, stages of development, parental involvement, and capabilities.

The system 10 also operates by way of the learner device 40. When the learner selects a subject/activity/skill to be learned or developed, the device 40 checks the cumulative learner performance database 30 and the individual learner performance database 50 to determine how the learner is learning or progressing relative to the other learners in the database 30 in terms of that specific subject/skill. Thus, the particular learner's performance data for that specific subject/skill is compared to the performance of other learners who are comparable to the particular learner in terms of at least one of: age, ethnicity, socio-economics, demonstrated ability, and other parameters. If this particular learner is lagging relative to a comparable group of other learners (as evidenced by the group's performance data in the database 30), then the device 40 randomly selects an available activity for that subject/skill appropriate for that particular learner's progress. The activity can already be resident on the device 40 or it can be downloaded from the server 20. As long as the check between the particular learner's performance data relative to a comparable group's performance data shows that the particular learner is lagging behind the group's performance data, then the device 40 will keep presenting that specific activity level or skill appropriate for that particular learner. Once the learner's performance data shows that the learner is at a level that is comparable (ie within acceptable limits) to the comparable group's performance level for that skill/subject, then the device 40 can present the learner with the next stage or level of activity for that particular skill or subject.

As a concrete example, the cumulative learner performance database may show that, within the database, learners at age 1 are able to count to the number 5 80-90% of the time (i.e. for every 10 tries, the learner at age 1 should be able to count to 5 eight to nine times out of the 10 tries). It should be noted that the performance level in this case is given as a percentage of success rate to account for errors. To account for a lower level of acceptable performance, the system 10 may be configured to accept a 70% success rate as being acceptable. Of course, a success rate higher than that shown by the group is also acceptable. Thus, if a particular learner can count to the number 5 with a success rate of 70%, then that learner is considered to be performing at about the same level as the comparable group whose data is in the cumulative learner performance database. If a particular learner is only able to count to 5 six times out of ten, then the device 40 and the system 10 will keep providing that particular learner with activities that relate to counting to 5. Once that particular learner's performance data has improved to at least 70% success rate, then the device 40 will provide with learner with activities that relate to the next related activity, that of counting to 6.

It should also be clear that while the device 40 can compare a particular learner's performance data for each skill to be developed or tested to the performance data of a comparable group from the cumulative learner performance database, this may also be done on a per subject basis. Thus, as an example, a particular learner may be lagging behind the group performance for the skill of counting up to 5 but that particular learner may, for the larger subject of math, be at the same level as the comparable group. Since every subject is divided into categories and each category is divided into sub-categories and each sub-category is divided into specific skills, then a particular learner may be lagging the group performance in a number of skills but, as a whole, that particular learner's performance may be in line with the rest of the group. As an example, if a subject is composed of a number of categories, sub-categories, and skills with a total of 100 skills, if a particular learner's performance indicates that, of the 100 skills, his or her skills are in-line with the group performance for 80 skills, then that particular learner is progressing at the same rate as the rest of the comparable group. However, of the 20 skills in which the particular learner is lagging behind, the system will keep presenting activities relating to those 20 skills to the particular learner until he or she is performing at the comparable group's performance level for all the skills.

The system 10 and, particularly the device 40, can be configured to provide the learner's parent or caregiver alarms regarding the learner's performance level relative to the comparable group. To determine if an alarm is required, the device 40 can use patterning to assess a particular learner's performance relative to the group. Thus, if, of the 100 skills in the above example, a particular learner is lagging in more than 50 of these skills, the system can generate an alarm to alert the learner's parent or caregiver. An email, text message, or similar communication can be sent by the system to the parent or caregiver. Similarly, if a particular learner has been lagging behind the group's performance for a significant period of time for a specific skill or skills (e.g. the learner is lagging in counting for 3 months), an alarm or alert can be generated. As well, if a learner has a particularly low level of performance for a given skill after a predetermined number of tries (e.g. 20 tries at counting to 5 and only a 30% or 40% success rate), the system may generate an alert to the caregiver or parent. Such alerts may recommend that the caregiver or parent seek 2 extra professional help for the learner in that particular subject or skill. As can be seen, if the particular learner's performance data indicates a pattern of learning behavior where the learner is consistently lagging behind the group's performance, then the learner's parent and/or caregiver can be alerted to this pattern. It should be noted that the pattern may be seen as lagging behind the group performance in a single subject, in multiple skills in multiple subjects, or lagging behind the group performance over a predetermined period of time.

As noted above, the device 40 can present the learner with an activity related to the subject or skill that needs to be taught or developed. To accomplish this, each available activity is tagged with one or more tags, each tag relating to the skill, subject, category, or sub-category to which the activity relates to. As an example, an activity where the learner has to identify 3 dogs and 4 cats in a picture can be tagged with MATH (for the subject), SCIENCE (another subject), ANIMAL IDENTIFICATION (for a category under science), NUMBER SENSE (for a category under math), COUNTING (as a sub-category under number sense), COUNT TO 3 and COUNT TO 4 (as skills under the sub-category counting), MAMMALS (as a sub-category under animal identification) and DOG and CAT (as skills under the sub-category mammals). With this classification and tagging of multiple activities with multiple tags, a search for activities with a specific tag will result in multiple possible activities. Another activity could involve counting the number of dots (4 dots on one wing and 5 dots on another wing) on a ladybug's wings. Such an activity may have the following tags: MATH, NUMBER SENSE, COUNTING, COUNT TO 4, and COUNT TO 5. To assist in randomly selecting an activity for a specific skill, subject, sub-category, or category, the device 40 aggregates the activities with the relevant tags and generates indices for each of these relevant activities. Then, using a random number generator (or a pseudo-random number generator), the device 40 generates a number. This generated number can then be processed so that it relates to the range of indices generated for the relevant activities. The activity whose index is closest to the generated number (after processing) is then presented to the learner as the selected activity. As an example, if a learner needs to be presented with an activity relating to counting to 5, the device 40 can aggregate the various activities tagged with the tag COUNTING TO 5 and can generate suitable indices for these activities. If, in one example, 10 activities were tagged with the relevant tag, these activities can be assigned indices 1 to 10. Then, using the random number generator (or a pseudo random number generator), the device 40 can generate a suitable number (e.g. 0.469). This number can then be multiplied by 10 (such that it falls within the range of the 1 to 10 indices). The closest index (i.e. 5) to the processed number (in this example 4.69) is thus the chosen index. Thus, the activity assigned with index 5 is thus presented to the learner as the selected activity.

As noted above, while some activities can be stored on the device 40, others can be downloaded from the server. To prevent having to generate multiple indices every time an activity is required, indices for various skills, subjects, categories, and sub-categories can be generated once for the activity database stored on the device 40 and these indices can be stored on the device. Thus, if an activity relating to the skill of identifying world landmarks is required, then the index list for that specific skill can be retrieved and a random number can be generated to determine which activity is to be presented to the learner. Similarly, if a learner is lagging in the subject of science and a science related activity is required, then the index list for activities tagged with the science tag can be retrieved and an activity can be selected using the process outlined above. However, once one or more activities are downloaded from the server, new indices may need to be generated as the activity database stored on the device 40 has changed. These new indices would need to take into account the newly downloaded activities from the server.

It should, of course, be clear that since each activity may have multiple tags and be associated with multiple categories, skills, sub-categories, and subject, every time a learner attempts or completes an activity, this generates multiple sets of data for different subjects, skills, and categories. Thus, if a learner completes the activity noted above of identifying 3 dogs and 4 cats in a picture, then this generates data for the math subject, the count to 4 and count to 5 skills, the science subject, the identifying dogs and identifying cats skills. Since the learner has successfully completed the activity, then this instance counts as a successful attempt for all of those various skills and would improve the learner's performance data.

As will be discussed in more detail below, the device 40 can automatically set parameters for each activity presented to the learner. Depending on the learner's progress for a specific skill, the device 40 may adjust the parameters of an activity to make the activity harder or easier to accomplish. This, if the learner is having issues with counting to 5, the parameters for the activity may give the learner more time to finish the task. Or, conversely, if the learner does not have any problems counting to 5 (e.g. he has succeeded 7 times out of 10), then the activity may be configured to give the learner less time and less chances to complete the activity.

For clarity, the subjects, categories, sub-categories, and skills may be different in different implementations. In one implementation, for the subject MATH, two of the subcategories and skills under the category number sense may be as follows:

Subject: Math

category: number sense

subcategory: counting
skill—count to 3
skill—count to 4
skill—count to 5

subcategory: differentiation between numbers
skill—differentiate between 3 and 4
skill—differentiate between 1 and 2
skill—differentiate between 2 and 3

For greater clarity it should be clear that a learner's performance may be assessed using many rubrics. As examples, whether the learner completes the activity may be one measure of performance, how long it took the learner to complete the task may be another measure of performance, how many successes the learner has had as a percentage of attempts at completing the activity may be another measure of performance. Similarly, the number of milestones completed or which milestones have been completed might be another measure of performance. Regarding milestones, the cumulative learner performance database may indicate that, at the age of x months of age, a learner should have completed milestones a, b, and c. If a particular learner has not yet completed or achieved milestones a, b, or c at the age of x months, then that particular learner is underperforming relative to the learners in the cumulative learner performance database. Thus, instead of a measure of a quantity by which a specific learner is underperforming (or lagging) relative to the comparable group (e.g. learner A only achieves counting to 5 60% of the time versus a group statistic of counting to 5 80% of the time), a milestone based performance assessment would only indicate whether a particular learner has achieved or not the same milestones as the comparable group. If the group has achieved more specific milestones than the particular learner at a particular age, then that learner is lagging or underperforming.

It should also be clear that the cumulative learner performance database and the individual learner performance database will have different contents. The individual learner performance database will be resident on the learner device and is for tracking, managing, and determining an individual learner's progress. As such, this individual learner performance database will have detailed entries for each time that particular learner uses the device and interacts with, completes, or attempts an activity presented by the device. The individual learner performance database will track each activity, each skill, each subject, each category, and each sub-category for that particular learner. The number of times a skill is tested, the number of times a particular activity is attempted, the success or failure of those attempts, the number of times a particular action is attempted in an activity (e.g. manually touching a dot on a multi-dot image), errors made by the learner, the types of errors made by the learner, and even the reasons for these errors are tracked by the individual learner performance database. The contents of the individual learner performance database is suitable for building a very detailed learner profile including that learner's strengths, weaknesses, educational capabilities, and skills.

In contrast to the above, the cumulative learner performance database merely tracks the end result of activities for available learners. Thus, as an example, if 100 learners are using devices in communication with the server, with 30 of those learners being 1 year of age and female, then a female 1 year old learner will have her performance assessed against those 30 learners whose activity performance will be stored in the cumulative learner performance database. Thus, if the majority of those 30 learners are able to count to 5 (as a skill) 80% of the time, then that particular 1 year old female learner should also be able to count to 5 at least 80% of the time. Every time one of the members of this group of 30 female 1 year old learners attempts an activity which is tagged with the skill of counting to 5, the result of that attempt is documented and uploaded to the cumulative learner performance database. The result of each attempt at an activity by a learner is documented, along with the various skills, subjects, categories, and sub-categories associated with that activity, and that result and activity and tags are all uploaded and incorporated into the cumulative learner performance database. Of course, the learner's age, gender, and other relevant data points regarding the learner are also uploaded and associated with the activity attempt and result. It should be clear that, depending on the implementation, the identity of the learner need not be stored on the cumulative learner performance database. Preferably, the cumulative learner performer database has enough data to determine the skills, abilities, and capabilities of a learner of a specific age, gender, and general profile. However, the cumulative learner performance database should not have data that can be used to pinpoint the skills and abilities of a specific learner.

For a milestone based implementation of the system, the cumulative learner performance database can store the results of attempts at specific milestones for the various learners. As with the explanation above, the cumulative learner performance database receives data from the various devices concerning the end result of attempts at activities by the various learners. Instead of a percentage of success for a specific skill, the cumulative learner performance database can store which milestones have been achieved by learners of a specific age, gender, or general profile. As an example, the cumulative learner performance database contents can indicate that 80% of male 20 month old learners in the system have achieved the milestone of identifying dogs. A male 20 month old learner should therefore also be able to achieve the same milestone. It should be quite clear that a learner's learner device only downloads the relevant data from the cumulative learner performance database or data that relates to the specific learner's age, gender, and general profile. Thus, the device being used by an 18 month old female learner would not download data relating to 24 month old male learners from the cumulative learner performance database.

It should be noted that the data in the cumulative learner performance database and in the individual learner performance database can be used to forecast potential issues with specific learners. The data in the cumulative learner performance database can be plotted alongside the data from the individual learner performance database. These two data sets can then be compared and forecasts can be made regarding an individual learner's potential future. To mitigate or even prevent potentially negative future consequences for a learner, remedial actions can be taken once projections about a learner's progress are made.

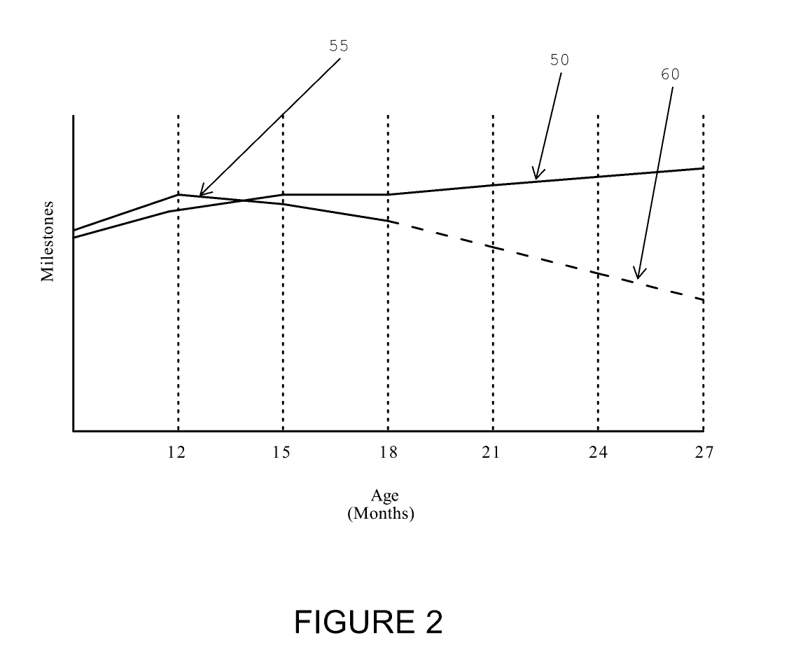

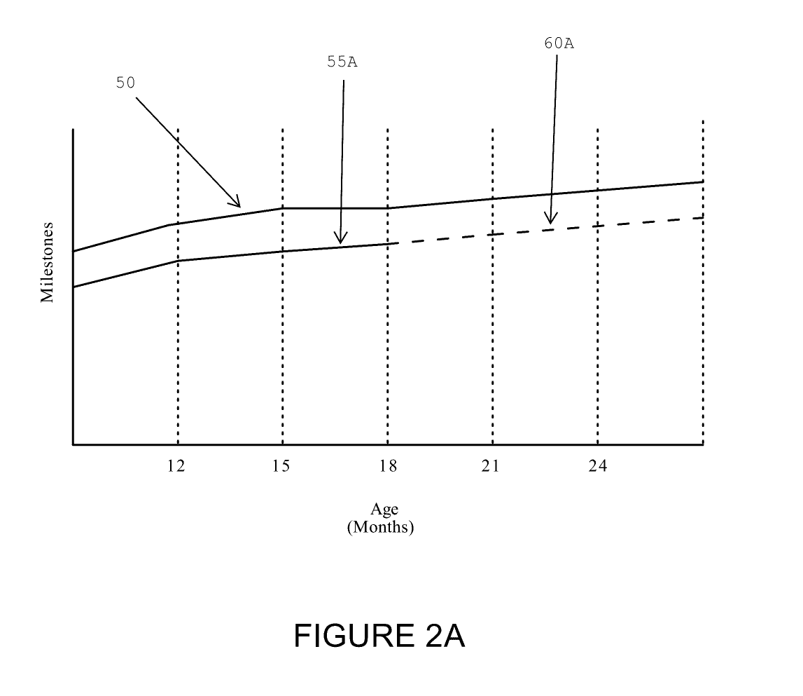

To explain the above, FIGS. 2 and 2A are provided. In these plots, the number of milestones achieved are plotted against a learner's age in months. As can be seen, the plot in FIG. 2 plots the number of milestones achieved by the group at specific ages from the cumulative learner performance database using a curve 50. Another curve 55 plots the number of milestones achieved by a specific learner at the same specific ages. It can be seen that, at 12 months of age, the specific learner is outperforming the group as the learner has achieved more milestones. However, at the age of 15 months, the specific learner is underperforming relative to the group and that this underperformance continues at age 18 months. The system extrapolates from this data (see section 60 in FIG. 2) and shows that, if the decline is not slowed or reversed, by the time the specific learner reaches 24-27 months, he or she will be severely underperforming relative to the group. The system can automatically plot the learner's performance for a given time period and extrapolate the learner's future performance based on the learner's previous performance data. Based on the configuration of the system, alerts can be sent to the learner's caregiver once data extrapolation indicates that the learner is in danger of being left behind or of severely underperforming relative to the group. The system can generate the plots every few months and send such plots to the learner's caregiver along with recommendations, suggestions, and alerts regarding the learner's performance. The system can be configured to determine a difference between the group performance and a projected performance of the learner and, if the difference is greater than a preset metric, the system can generate and alert and recommend remedial action.

It should, however, be noted that underperformance relative to the group may not necessarily cause alarms to be generated. Referring to FIG. 2A, another plot using the same data for the group is presented with data for another specific learner. As can be seen, the group's performance data in curve 50 is the same as that in FIG. 2. However, curve 55A is for another specific learner and it can be seen that this specific learner is slightly underperforming relative to the group. FIG. 2A also shows that the specific learner's performance is consistent and that the extrapolated or projected learner performance (see curve 60A) actually tracks the trajectory of the group's performance. While the learner may not achieve the same number of milestones as the group, this consistency in performance and in performance trajectory may indicate that the learner is not in danger of severely underperforming. Of course, the system may still generate these performance plots and performance plot extrapolations and present these to the learner's caregiver.

While the system may automatically project a learner's future performance based on that learner's historical past performance, the plots generated may also be used in conjunction with suitable advice and counselling from qualified education counsellors to properly plan any future educational actions. Of course, such actions may include remedial steps to mitigate if not reverse any potential future underperformance by the learner.

Each learner computing device may take the form of a tablet computing device, a smartphone, a computer notebook, a netbook, or any other device which may be used for data processing. Preferably, the learner computing device is portable. The learner computing device should, preferably, be able to communicate wirelessly with the cumulative learner performance database and/or the server as well as with any other wireless computing device or network.

In one configuration, each learner computing device is used by a single learner. For this configuration, each learner is provided with a profile on the cumulative learner performance database server so that each learner's performance for activities can be stored, tracked, and analyzed. As noted above, each learner's performance is also tracked and analyzed on the device's individual learner performance database.

For ease of use by learners, it is preferred that the learner computing device be equipped with not just a graphical user interface but with a touch screen based GUI. As well, it is highly preferred that the device be equipped with a voice capable user interface. For younger learners, each activity may provide voice instructions to the learner on how to conduct/complete the activity. This removes the need for learners to read on-screen instructions.

The server can be any suitable desktop, laptop, or other type or form of computing device which can communicate wirelessly with the various learner computing devices. Of course, such a server should also have the capability to operate, store, update, and manage the cumulative learner performance database as well as the activity database.

The cumulative learner performance database can be resident on the server or it can be resident on another server at another location. As noted above, the cumulative learner performance database receives performance data from the various learner computing devices being used by the various learners. The data on the cumulative learner performance database can be mined and retrieved by the various learner computing devices to determine if the learner using the learner computing device is performing in line with their comparable groups. As can be imagined, a device being used by a 24 month old learner would need data for other 24 month old learners from the cumulative learner performance database while a device being used by a 36 month old learner would need performance data for other 36 month old learners.

The various components of the system illustrated in FIG. 1 can communicate with one another wirelessly. The different components (i.e. the various learner computing devices as well as the various databases on the server) can be wirelessly networked to each other using a wireless network which uses well-known wireless network protocols. Communications between the various components can be effected by using specific modules tasked with dealing with a specific component. As an example, the learner devices may be equipped with a module for dealing with the packaging and transmission of learner performance data to the server for storage in the cumulative learner performance database. Similarly, the same device can also be equipped with a module for receiving processed data from the server and for processing that data for use in determining which activity to present to the learner. As well, the same device can be equipped with a module to receive other modules which would be able to present other activities to the learner. Thus, each learner computing device can be equipped with a module for sending performance results or performance data to the cumulative learner performance database and another module for receiving data and activity modules from the server.

For ease of implementation, the various learner computing devices, server(s), and the various databases can all be connected or communicating with one another using the Internet. The cumulative learner performance database may be physically housed in different servers but logically located as if it was on a single server and be accessible to the various devices and servers through the Internet. The cumulative learner performance database may also comprise multiple databases containing different data sets and data types as will be explained below. Instead of a unitary database, the cumulative learner performance database may be separated into discrete portions, each containing different datasets for different localities or for different groups or sets of learners or for use in different aspects of the present invention and for use in different manners by these different aspects of the present invention.

It should be noted that the activity that each learner engages in using the learner computing device can be any suitable digital device based activity. Activities that are based around simpler tasks such as counting, identifying specific animals or icons, and the like are suitable for this invention. Of course, more complex tasks such as spelling, difference recognition, arithmetic-based activities, and other activities with an educational component may also be used. Preferably, the activities selected for the present invention involve the learner selecting his or her answers from a range of possible answers with the learner indicating his or her choice by touching the selected answer or answers. The learner can be presented with the activity and then be given a range of potential answers. The learner can then touch selected answer or answers from the options given on the touch screen interface. If the selected answer or answers are incorrect, then the activity can iterate a number of times to provide the learner with multiple opportunities to select the correct answers. To assist the learner, each iteration (after the first) may have fewer potential answers than the immediately preceding iteration. This provides the learner with fewer options and, thus, a greater chance at selecting the correct answer or answers. Part of the parameters sent by the educator computing device to the learner computing devices may be the number of iterations allowed, the type of changes in the activity for each iteration (e.g. are the number of options to be decreased/is the number to be counted to be changed), how many options are to be given for each iteration, and the amount of time allowed for the learner to complete the activity per iteration (e.g. for the first iteration, the learner may be given 45 seconds, for the second iteration, the learner may be given 40 seconds, for the third iteration the learner may be given 30 seconds, etc., etc.).

From the above, a number of examples can be given to assist in further description. One example relates to a counting-based activity. The learner is provided with a picture of a beetle or lady bug with spots on the wing. The learner is then prompted to count how many spots or dots are on the lady bug's wings. Based on the configuration, the learner either enters how many dots are counted on the wings by selecting from a number of options or the learner can individually touch each and every dot on the wing and only after this can the user enter the number of dots counted. In the event the learner does not perform a proper count of the dots on the lady bug's wings, subsequent iterations can reduce the number of dots on the lady bug. Conversely, instead of changing the number of dots, the number of dots may stay the same but the numbers provided as options may be changed between iterations. In terms of the learner's performance, this can be based on how many iterations were needed to select the correct number of dots. Similarly, further performance can be measured by determining whether the learner only activated or touched each dot once.

Another example of an activity which may be used with the system in FIG. 1 relates to spelling. The device may aurally provide a word to be spelled to the learner with the learner computing devices. The learner computing devices may then provide the learners with a listing of an alphabet and a number of blank spaces corresponding to the letters of the word that the learner was asked to spell. The learners can then drag specific letters to the blank spaces. Alternatively, to make the activity easier, instead of presenting the learners with a full alphabet, a subset of the alphabet can be presented, thereby limiting the learner's options. Or, in another alternative, all the letters which spell out the word can be presented to the learner in a jumbled fashion. The learner merely has to drag each letter to its proper position in the word blanks to properly complete the activity. A further alternative may show the learner some of the letters which form the word. The learner merely has to fill in the blanks for the rest of the letters for the word. As part of the parameters set by the device, the parameters may include the amount of time allowed to the learner per iteration, the number of extra letters shown to the learner, and whether some letters of the word are to be revealed to the learner.

Another further example of an activity which may be used for this invention involves the learner matching young animals with their parents. For this activity, the learner is presented with a number of young animals on one row and a number of adult animals on another row. The learner has to pair each young animal with its corresponding adult version (i.e. pair up a child animal with its parent). Performance and progress for the activity can be measured by the learner's success rate as well as the number of iterations or attempts before all the young animals are properly paired with their parent.

Once the learner has completed the activity or once the time allotted for the activity has passed, the learner's performance-related data is gathered at each of the learner computing devices. This performance related data is then stored on the learner computing devices in the individual learner performance database. The result of the activity and the general profile of the learner (including the learner's age, gender, etc.) can then be transmitted to the cumulative learner performance database. As noted above, the performance data may take different forms and may measure different metrics. These forms and metrics may, of course, be dependent on the activity. The data package sent from each learner computing device to the server for the cumulative learner performance database may include an identification of the learner's age/gender, the performance data, an identification of the activity for which the performance data relates, and an identification of the result of the activity. The data package may be sent to the cumulative learner performance database using well-known wireless protocols and well-known data transfer techniques.

At the cumulative learner performance database, this database receives these database entries using suitable hardware and the data package containing the performance data is received from each learner computing device. The data in the data package is then extracted and stored in the cumulative learner performance database.

When the device is about to select an activity for a learner, the device first determines if the learner's performance is in-line with those of a comparable learner group. The device communicates with the server and, using the server, the relevant data for a group of learners comparable in age (and possibly gender as well as other general profile characteristics) to the specific learner is retrieved from the cumulative learner performance database and this performance data for the group is analyzed. The analysis may be as simple as determining the group's performance relative to a specific skill, subject, category, or sub-category. Once this analysis has been performed, then the data from the cumulative learner performance database can be compared to the specific learner's performance data relative to the specific skill, subject, category or sub-category. This comparison is, preferably, performed at the device to avoid having to upload the relevant specific learner data to the server. This comparison can thus reveal whether the specific learner is outperforming, performs as well as, or underperforms relative to the rest of the group. Depending on the result of the comparison, the device can thus present an activity that is at the level of the group's performance (to bring up the specific learner's performance) or at a lower level (to reinforce a basis for a higher level activity).

It should also be noted that the device may perform a more intense analysis of a learner's performance, including his or her performance in a variety of activities and with data gathered over a period of time. Such a deeper analysis, when compared with data from the rest of the group of learners, can be used to determine how a specific learner is performing relative to the group.

The data stored on the device may also be used by the learner's educators or caregivers to assess the learner's progress. This data may be viewed using the learner's computing device or it may be downloaded and viewed using another device. The manner in which the data is displayed may depend on the configuration of the learner computing device (or whatever device was used to access the data) as well as the activity to which the data relates. As an example, if the activity relates to counting items on the screen, the performance data could be presented as scores or bar graphs denoting how many errors each learner made, how many iterations were needed before each learner to garner a perfect performance, and how long it took each learner to count the items. Similarly, if the activity was spelling based, the number of errors made by the various learners can be displayed numerically. For the spelling activity, the number of learners who spelled the word correctly can be portrayed as a portion of a pie graph. The use of line, bar, or pie graphs can quickly and easily provide the educator or caregiver with a visual indication of the learner's success in the various activities.

The individual learner performance database noted above and which is used in the invention has a unique structure that allows other applications to take advantage of the benefits of the system.

The individual learner performance database has a structure wherein each item is provided with its own table and the columns within that table describe the item. To ensure suitable flexibility in how the system may be used and flexibility in the applications and activities that may use the system, each activity will produce specific database entries for the learner using that activity or application. In one implementation, the learner's performance is tracked by the database entry produced every time the learner uses that activity/game/application. Thus, every time the learner uses that game/application, a database entry is generated on the computing device for the individual learner performance database. This database entry is then stored in the individual learner performance database. A sample format for such a performance data database entry (in an embodiment using milestones) is provided below:

| | | | | | |
|---|---|---|---|---|---|
| | | | Target | | |
| | App | Milestone | Level | Result | Reason |
| Time | ID | ID | ID | ID | ID |

To explain the various columns in the above database entry, the following table is provided:

| | |
|---|---|
| Time | Time that the data was taken |
| App ID | ID of the application which points to a row |
| | in the Application table which describes the |
| | Application which the learner is running |
| Milestone ID | ID of the milestone which points to a row in |
| | the Milestone table which describes the |
| | milestone which is being measured |
| Target Level ID | ID of the target level which points to a row |
| | in the Target Level table which describes |
| | the targeted level of the milestone which is |
| | being measured |
| Result ID | ID of the result which points to a row in |
| | the Result table which describes the result |
| | of the measurement |
| Reason ID | ID of the reason which points to a row in |
| | the Reason table which describes the reason |
| | for the measured result |

As can be seen from the above, each item, whether it is an application, a milestone, a result, or even a reason for the result, is given its own table. In implementations where the device is used by multiple learners a separate entry, identifying the learner for whom the database entry applies, may be used. Such an entry, e.g. a learnerlD, would be a unique identifier which specifically identifies one specific learner.

To further explain the above table and how the various columns and tables provide flexibility for applications and for sorting results, the various items in the columns are described below.

The performance data embodied in the various tables and columns noted above are based on the following performance parameters: Milestones, Target Level, Result, and Reason. The other parameters are provided in the individual learner performance database entry to specify the various applications and activities for which the data is for and to allow for easy sorting of the data.

For the Milestone performance parameter, its corresponding Milestone table will have a number of entries which describe the different milestones which are being tested by a game or application or an activity. As an example, if a counting game such as the beetle or lady bug game described above was the activity, one parameter which could be tested would be the learner's ability to perform a visual assessment (i.e. visually determine the number of dots on the ladybug's wings). For this example, “Visual Assessment” would be an entry in the milestone table. As noted above, a Milestone can be defined as a skill, ability, or capability which is desired to be cultivated, taught, or nurtured in the learner. Once the learner has shown some facility in this skill, ability, or capability, the milestone can be listed as being achieved. Milestones can be cumulative such that higher level target milestones are only achieved or are only achievable once specific lower level milestones have been achieved. As an example, 3 or 4 specific lower level milestones may be required to have been achieved before a learner is provided with an activity for a higher level milestone. It should be noted that the lower level milestones do not necessarily have to relate to the higher level milestone.

For the Target Level parameter, its corresponding Target Level table will have a number of entries, each of which describes a different level of the milestone being tested. To allow for this parameter to applicable to different milestones, the level can be kept generic or general. Continuing the ladybug example game above, when testing the learner's ability to perform a visual assessment, the application or activity can start by showing a random number of dots. In this example, the Visual Assessment milestone would have various Target Levels, each of which is derived from the number of dots presented to the learner. As such, the various entries in the Target Level table could be 2, 3, 4, and 5 as these would be the number of dots presented to the learner. In other words, the entries in the Target Level table are what the learner should be attempting to achieve to reach the milestone being tested. For the ladybug game, the target levels are the number of dots on the ladybug's wing that the learner has to visually assess.

For the Result parameter, the Result table has rows which describe the result which are measured during the testing for the milestone. This parameter is preferably kept generic so that different types of tests and measurements can use the parameter. As an example of how this parameter operates, we can again use the example ladybug game described above. For the ladybug game, when the visual assessment milestone is measured, there are only two possible results: a correct or an incorrect visual assessment. It should be noted that, for other milestones, the Result parameter may include other possible results.

For the Reason parameter, the corresponding Reason table contains rows which describe the possible reasons for the result which was measured. For the ladybug game example, the visual assessment milestone may have reasons would include: “child has counted more items than shown”, “child has counted fewer items than shown” and “child has counted number of items shown”. The entries in the Reason table are therefore the justifications for the results of the performance measurements.

It should be noted that the entries in each of the tables for the above parameters can be re-used by multiple games or applications or activities. It is preferable that the entries in these tables are reused when measuring the same feature to assure that analyses using the data in the database are performed correctly. As an example, two applications may both measure “Visual Assessment”. Both applications will have to store the data under the same milestone ID of “Visual Assessment” and use appropriate Target Level, Result and Reason ID entries. If the use of these parameters is consistent, a query for data for a child's performance on “Visual Assessment” will provide consistent results.

As noted above, each learner computing device gathers performance data for each instance a learner uses an application or activity. Below is provided a simplified version of a database entry that a learner computing device compiles in the individual learner performance database.

| | |
|---|---|
| Time | 11:23:44 am |
| App ID | App 1 |
| Milestone ID | Visual Assessment |
| Target Level ID | Count to 3 |
| Result ID | Incorrect |
| Reason ID | child has counted fewer items than shown |

The above individual learner performance data database entry was for the ladybug example game previously described. For this example instance, the learner was shown 3 dots and the learner selects a count of 2. For the next iteration of the activity, the learner is shown 2 dots and the learner correctly counts 2 dots and correctly enters 2 dots. The resulting database entry generated then becomes:

| | |
|---|---|
| Time | 11:25:44 am |
| App ID | App 1 |
| Milestone ID | Visual Assessment |
| Target Level ID | Count to 2 |
| Result ID | Correct |
| Reason ID | child has counted number of items shown |

The database system also allows for finer granularity in the data such that more detailed searches and data analysis can be performed for an individual learner's capabilities. One example of such a capability requires more entries in the milestone table. An added milestone can be titled “Visual Assessment plus Continued Counting” with its own set of data for the Milestone, Test Level, Result and Reason tables. For this set of data, some of the values may overlap with the set of data for the Visual Assessment milestone.

In the above example for Visual Assessment plus Continued Counting, the Target Level can be very specific (e.g. “visual assessment of 4 dots plus continued counting of 3 dots”) or it can be less specific (e.g. “count to 7”). The detail level for the Target Level may depend on the specificity desired for a search and analysis. The data in the individual learner performance database can be data mined by the device or by an educator or caregiver to determine what issues the learner may be having or what the learner's strengths are.

Continuing the above example for Visual Assessment plus Continued Counting, the entries in the Result table can be set to “correct” or “incorrect”. The reasoning for the result achieved can be placed at the Reason table.

For the Reason table for this new milestone, two approaches can be taken: very detailed Reasons can be given or more generic Reasons can be used while categorizing the results. The detailed reasons can describe what the learner did and how these actions were correct or incorrect. As examples, these detailed reasons can include: “items on right are touched once and result is correct”, “items on both left and right are touched once and result is correct”, “items on left and right are touched once and result is incorrect”, “items on right are touched once and result is only right items”, “items on right are touched more than once and result is more than the items on the right”, and “items on right are touched once and result is more or less than total number of items”. These entries may, of course, be predetermined and be entered into the individual learner performance database upon the detection of specific actions by the learner when performing or attempting a specific activity.

Conversely, the less detailed but categorized reasons can include: “child is not visually estimating”, “child is using wrong reference”, “child is skipping numbers”, and “child has counted number of items shown”. Of course, the determination as to when to use which result and which reason is based on the internal logic of the application or activity.

For this new milestone, an application or activity can generate the following database entry for storage in the database:

| | |
|---|---|
| Time | 11:25:44 am |
| App ID | App 1 |
| Milestone ID | Visual Assessment and Continued |
| | Counting |
| Target Level ID | Count to 7 |
| Result ID | Correct |
| Reason ID | child has counted number of items shown |

The above database entry was created after the learner was presented with 3 dots on a left wing of a ladybug and 4 dots on a right wing of a ladybug in an activity where the learner has to determine how many dots are present on the ladybug and to touch or activate some of the dots on the ladybug. For this database entry, the learner touched each of the 4 dots on the right wing and was supposed to visually estimate how many dots were on the left wing. The learner then selected a total number of 7 dots.

For the next iteration of the example, the learner is presented with 5 dots on one wing and 5 dots on the other wing. After the learner touches all the dots on one of the wings once and selects a count of 8, the following database entry is produced:

| | |
|---|---|
| Time | 11:26:44 am |
| App ID | App 1 |
| Milestone ID | Visual Assessment and Continued Counting |
| Target Level ID | Count to 10 |
| Result ID | Incorrect |
| Reason ID | child is skipping numbers |

As can be seen, the learner correctly counted the dots by touching them. However, the learner's incorrect result shows that the learner is not keeping proper track of the numbers.

In another example, the learner is shown a ladybug with 2 dots on the left wing and 4 dots on the right wing. The learner then touches all the dots on both wings and enters a value of 6. This instance of the use of the application results in the following database entry:

| | |
|---|---|
| Time | 11:26:44 am |
| App ID | App 1 |
| Milestone ID | Visual Assessment and Continued Counting |
| Target Level ID | Count to 6 |
| Result ID | Incorrect |
| Reason ID | child is not visually estimating |

As can be seen from the database entry, the learner is not visually estimating the number of dots as the learner is touching and counting all the dots.

As noted above, the milestones used in the database can be cumulative such that achievement of lower level milestones can lead to the achievement of higher level milestones. As an example, from the above example of counting dots on a lady bug, if the learner was originally presented with 3 dots on the ladybug and then is presented with three more dots, if the learner only touches the further 3 dots, a table for the milestones and results may be as follows:

| Milestone | Target Level | Result | Reason |
|---|---|---|---|
| 3100-04 - | Count to 6 | Correct | Learner has |
| Point and | | | counted number of |
| count | | | items shown |
| 3100-05 - | Count to 6 | Correct | Learner has |
| Sequential | | | counted number of |
| quantity | | | items shown |
| 3120-01 - | Count to 6 | Correct | Learner has |
| Count | | | counted number of |
| starting at | | | items shown |
| 2, 3, 4, or 5 | | | |
| 4100-01 - | Count to 6 | Correct | Learner has |
| Continued | | | counted number of |
| count and | | | items shown |
| visual count | | | |

As can be seen from the above, the higher level milestone (continued count and visual count) builds on the lower level milestones. Specifically, the milestone denoted by the code 4100-01 requires the milestone denoted by 3120-01 to work. For clarity, it should be clear that “continued count” cannot operate without the lower level milestone of “count starting at 2, 3, 4, or 5”. Of course, while the above shows that some target milestones may depend on lower level milestones, this is not necessarily the case for all milestones. Some target milestones may require lower level milestones which are not directly related to the target milestone.

To assist an educator or caregiver in determining a learner's progress, a report regarding the data processed from the individual learner performance database may be generated. In one implementation, the report provides details on the learner's progress towards a specific target milestone. In another implementation, the report provides details for the learner's progress relative to the progress of a comparable group of other learners. As an example, the report can detail how many milestones have been achieved by the specific learner and how many milestones (in the same subject) has been achieved by the comparable group of learners. As well, the report can detail which lower level milestones were achieved by the learner for target milestone which have not been achieved. This type of report can show how far or how close the learner is when it comes to achieving desired milestones. The report can even provide reasons, culled from the database data, as to why the learner failed to achieve the target milestones. As will be explained below, the report may also contain recommended activities and learning materials for the learner. Of course, these recommended activities and learning materials may be based on the learner's performance or progress. As well, these recommended activities and learning materials can be based on the learner's determined shortcomings or unachieved milestones.

The use of these above specific parameters allows for a common assessment platform to be used among different activities, applications, and games. For ease of use of these parameters across different applications and activities, it is preferred that developers of these applications use the specific parameters as outlined above. Such use would allow for consistency in the application of the parameters and in the results of data mining in the individual learner performance database.

Regarding the implementation details for the two performance databases, it should be clear that various tables will need to be defined and created in the different performance databases and in the various computing devices involved in the system. The design and the implementation of these various tables are within the purview and capability of a person skilled in the art.

In one implementation, the individual learner performance database may include a reference database containing a complete list of achievement milestones and sub-milestones with age and level references. Data collected each time a learner uses an application is compared against these milestones and sub-milestones. If necessary, this comparison can also take into account the specific learner's age. In addition to the reference database with the milestone related data, the individual learner performance database also includes a learner specific database containing historical data collected from the learner. Every time the learner uses specific learning material on the learner computing device, data is gathered on how the learner performed when using the learning material. This data can be used to determine how the learner is progressing towards pre-determined achievement milestone targets. The data gathered can be stored in the individual learner performance database. Each device can include a learner profile which contains learner achievement records based on the target milestones for that specific learner. These profiles can, depending on the implementation, also be uploaded to the cumulative learner performance database.

As noted above, each learner computing device delivers the learning activity to the learner with the learner computing device gathering data regarding the performance of the learner in the activity. The learner computing device then stores the data as a database entry in the individual learner performance database. The result of the activity, as well as other pertinent and relevant data, is then uploaded for storage in the cumulative learner performance database. The data stored at the individual learner performance database for storage can be cross-referenced with specific milestones, both lower level and upper level milestones to determine the learner's progress. The data stored in the cumulative learner performance database can then be retrieved to assess each learner's progress relative to a comparable group of other learners.

In addition to the various milestones associated with the various activities, the reference database can also include a database for recommended activities and other learning material which can be used to address learner issues. As an example, if a learner's performance data indicates that the learner is deficient in one area or does not seem to understand to achieve a particular milestone, the reference database contains activities or other learner material which can be used by or in conjunction with the learner to address the learner's issues. Thus, as an example, if a learner seems to be unable to count to 10, the reference database can contain activities or learning material that covers counting to 5, counting to 7, and counting to 8. For this example, the reference database contains activities or learning materials that can be used to check to see if the learner can count to a lower number. If the learner cannot count to the lower number then the learner will need to learn or master these activities before he or she can proceed to counting to 10. For a simpler implementation, the reference database may have entries which, when accessed, details lower level activities that can be used to build up to the higher level activities. Other entries, each of which may be associated with different milestones, can detail other activities or learning materials which can be used to address learner issues.

In use, when a learner's performance data relative to an activity is analyzed and the milestones achieved or not achieved by the learner are determined, the end result of the analysis can include a reference to the reference database. As noted above, the reference database includes entries associated with different milestones. The entries associated with the milestones that the learner failed to achieve for the activity can thus be accessed and the activities and learning materials in the entries can be used by the device to automatically present these activities to the learner. The device can present these materials and activities to the learner as remedial activities or learning materials which can be used to address the areas in which the learner underperformed.

The reference database can also be used to determine a learner's performance relative to not just which milestones are associated with the activity just completed but with all available milestones. After a learner's performance data has been stored in the individual learner performance database, the performance can be assessed/analyzed against all or most of the milestone entries in the reference database. This step will ensure that, regardless of the learner's performance relative to the milestones for the activity, the learner will be awarded with milestones he or she has achieved even if the milestones do not directly related to the activity just completed. Thus, if a learner fails a specific activity, the learner can still be awarded milestones that he or she has achieved even if the milestones are not for that particularly activity. Similarly, if a learner has overachieved or has done really well in an activity, the learner may be awarded milestones that are beyond what he or she may be otherwise entitled to. As an example, doing very well in one activity may provide a learner with milestones that leapfrogs or avoids other activities.

In one implementation of the invention, a home setting is contemplated. For such a home setting, the learner can be a child equipped with a learner computing device. The learner can be assisted by a parent, tutor, relative, or similar person who has an education-related function.

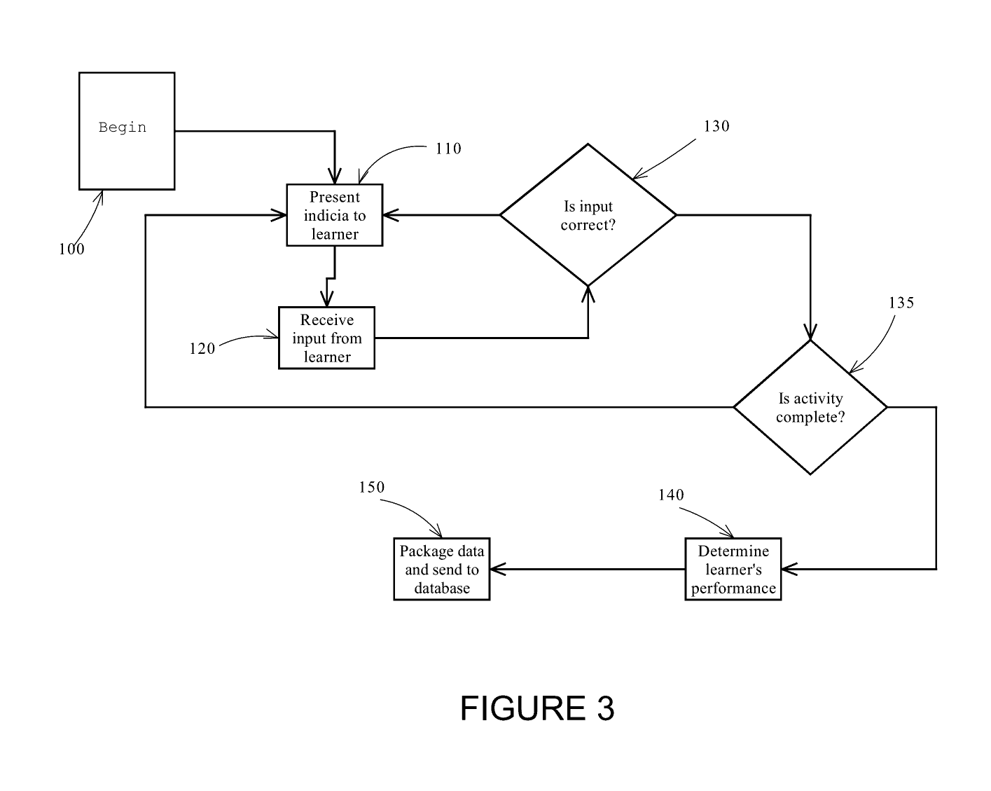

Referring to FIG. 3, a flowchart for the steps in a method according to another aspect of the invention is illustrated. Step 100 notes the beginning of the activity and the learner is presented with indicia relating to the activity (step 110). This indicia can take many forms and is dependent on the activity. As an example, for the counting activity described above, the indicia can be a bug with a number of dots (which may be activated by the user) on its wing. Similarly, if the activity is that of matching young animals with their parents, the indicia includes not just the young animals but the parent animals and whatever background art may be necessary or desirable. The indicia may, of course, be configured so that the learner can interact with the indicia. Thus, the learner may click, drag, tap, activate or otherwise interact with at least some of the indicia to provide input for the activity.

Once the indicia has been presented to the learner, the learner computing device then receives input from the learner by way of the learner interacting with the indicia (step 120). This step continues until the learner has completed input for the activity. The learner's input is then determined to be correct or incorrect (step 130). If the learner's input or set of inputs is incorrect, the logic of the method loops back to step 110 as the indicia is, again, presented to the learner. Steps 110-130 iterate until the learner completes the activity by correctly entering a suitable set of inputs that correspond to predetermined correct inputs or until a set number of iterations have been completed. Of course, as noted above, the set number of iterations may be determined by one of the parameters received from the educator computing device. It should be noted that the indicia may be changed at each iteration of steps 110-130.

Once the learner has completed the activity or once the number of allowed iterations has been reached (decision 135), the performance of the learner is then determined (step 140). This step may involve counting the number of iterations until the activity was completed, determining if the activity was successfully completed at all, determining how long it took to complete the activity, and determining if any errors (and how many) were made before the activity was completed. Of course, other performance measures may be used to determine the learner's performance relating to the activity.

With the performance data gathered, this performance data can then be packaged as a data package or as a database entry for storage and/or transmission in either or both the individual learner performance database and the cumulative learner performance database. In one implementation, the data package/database entry is transmitted to the server where at least one of the databases reside (step 150).

As can be seen from the above, another aspect of the invention involves determining a learner's progress towards achieving a target milestone. The method for this aspect of the invention starts with providing the learner with digital content with an educational component. This is done by way of the learner computing device. The learner then completes the digital content's activity/application and the learner computing device gathers the learner's performance data. The performance data is then packaged as a database entry and is uploaded to a database. Once in the database, the system can formulate performance reports based on specific parameters. Similarly, group performance data can be collated and aggregated so that it can be sent to specific devices which need such data for comparison with specific learner performance data. The collated data may detail a specific target milestone and may illustrate how many learners in a group have achieved that milestone based on the data in the cumulative learner performance database. In addition to documenting how many learners met the milestone, the collated data can provide further details as to how many learners did not achieve the target milestone and which lower level milestones were achieved by these learners. This is done by the server mining the cumulative learner performance database for the highest milestones achieved by each learner in the group and retrieving reasons for those achievements. Of course, milestones may be broken up into subject areas or categories if desired. Each device can also provide recommended activities and other materials for each of the learners based on their achieved milestones. This aspect of the invention can be constructed by cross-referencing each learner's learner profile (including their achieved milestones) with the reference database and its entries regarding each milestone and recommended activities. Each learner's unachieved milestones (i.e. milestones which were highlighted by completed activities but which were not achieved by the learner) can be extracted from each learner's profile and the recommended activities for these milestones can be included in the report for each learner.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g. “C”) or an object oriented language (e.g. “C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for delivering activity content to a learner, the system comprising:
a server;
a cumulative learner performance database on said server, said cumulative learner performance database being for storing results of attempts at completion of activities by said learner and other learners, said cumulative learner performance database being updated after every attempt at completion of an activity by said learner;
a learner computing device, said learner computing devices being for use said learner and being in communication with said server, said at least one learner computing device determining an activity to be presented to said learner;
an individual learner performance database resident on said learner computing device, said individual learner performance database being for tracking a progress of said learner, said individual learner performance database being updated with said learner's performance whenever said learner interacts with an activity on said learner computing device, said individual learner performance database storing at least one performance metric for said learner for at least one activity accessed through said at least one learner computing device;
an activity database storing a plurality of digital activities for presentation to said learner by way of said learner computing device, said learner computing device automatically selecting said at least one activity from said activity database;
wherein
said learner computing device communicates with said server to retrieve performance data relating to at least one skill or subject from said cumulative learner performance database for other learners comparable to said learner in at least one general profile characteristic;
said learner computing device retrieves said learner's performance relating to said at least one skill or subject from said individual learner performance database;
said learner computing device performs a comparison of said performance data from said cumulative learner performance database with performance data for said learner from said individual learner performance database to determine which activity to present to said learner;
after every interaction by said learner with an activity on said learner computing device, said learner computing device uploads to said server results of said interaction to thereby update said cumulative learner performance database;
said learner is a child of under 60 months in age.

2. A system according to claim 1, wherein said learner computing device communicates with said server wirelessly.

3. A system according to claim 1, wherein said learner computing device is a portable, touch enabled computing device.

4. A system according to claim 1, wherein said learner computing device is equipped with a voice interface for providing aural instructions to said learner for said activity.

5. A system according to claim 1, wherein, if said comparison indicates that said learner is lagging in performance when compared with said other learners, said learner computing device selects a selected activity for reinforcing said at least one skill or subject from said activity database.

6. A system according to claim 5, wherein said selected activity is selected by said learner computing device using a pseudo-random number generator.

7. A system according to claim 1, wherein at least a portion of said activity database is resident on said learner computing device.

8. A system according to claim 7, wherein a remainder of said activity database is resident on said server, said learner computing device downloading modules from said server as necessary for activities to be presented to said learner.

9. A system according to claim 1, wherein said performance data indicates which milestones have been achieved by said other learners for said at least on skill or subject.

10. A system according to claim 1, wherein said performance data indicates a percentage of success for said at least one skill achieved by said other learners.

11. A system according to claim 6, wherein said learner computing device generates an index for each activity tagged with a relevant skill and uses said pseudo-random number generator to generate a number which is used to find said activity using said index and said number.

12. A system according to claim 1, wherein said learner computing device determines a pattern of learner performance to determine an activity to be presented to said learner.

13. A system according to claim 12, wherein if said learner computing device determines a pattern of underperformance by said learner relative to said other learner, an activity selected will relate to said skill or subject.

14. A system according to claim 12, wherein if said learner computing device determines a pattern of other than underperformance by said learner relative to said other learners, an activity selected will relate to another skill or subject.

15. A system according to claim 1, wherein said activity for said learner involves at least one of: counting, spelling, arithmetic, and matching images.

16. A system according to claim 1, wherein said activity database includes a reference database containing entries for different milestones achievable by said learners upon completion of various activities.

17. A system according to claim 1, wherein said results after said interaction include at least one of:
duration of said activity;
number of iterations for said activity in the event said learner is unable to complete said activity; and
changes to said activity for each iteration.
